(19) United States
(12) Patent Application Publication
(10) Pub. No.: US 2020/0134840 A1
(43) Pub. Date: Apr. 30, 2020

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Shinichi Mitsumoto, Saitama-shi (JP)

(21) Appl. No.: 16/667,320

(22) Filed: Oct. 29, 2019

(30) Foreign Application Priority Data
Oct. 30, 2018 (JP) 2018-204345

(51) Int. Cl. G06T 7/246

(52) U.S. Cl. CPC G06T 7/246; G06T 2207/10016; G06T 2207/30201

(57) ABSTRACT

In a moving image, as a motion section, a section including a plurality of consecutive frames related to a motion of a photographer of the moving image is specified. The ratio of frames in which a specific object is detected in the motion section is obtained. A motion section to be extracted as a highlight from among motion sections each specified from the moving image is determined, based on the ratio obtained for each of the motion sections.

### BACKGROUND OF THE INVENTION

### Field of the Invention

The present invention relates to a technique for specifying a frame section, from a moving image, used for generating a moving image having a playback time shorter than that of the moving image.

### Description of the Related Art

In recent years, with the popularization of digital cameras and smartphones, it has become easier to shoot moving images, so many users have unedited moving images shot by themselves. The is a widely known method in which, in order to prevent a user becoming bored when it takes too much time for a moving image to playback when the user views the moving image, the user views a moving image in which only a highlight of the moving image is extracted and the playback time is shortened. Highlight means a characteristic portion (e.g., the most interesting or memorable scene) within the moving image.

However, it is very troublesome to create a moving image in which a highlight is manually extracted from the moving image. As a method of creating a moving image from which a highlight is automatically extracted, a method of selecting, as a highlight section, a section in which frames whose evaluation value obtained by evaluating frames extracted from the moving image is equal to or larger than a threshold value are consecutive is proposed as in International Publication No. 2005/086478.

However, in such a method, there is a possibility that an unnecessary section will be selected instead of a section that the photographer particularly intended to shoot. In order to solve this problem, International Publication No. 2005/086478 proposes a method of totaling a plurality of evaluation values obtained by evaluating frames, such as information that an object was detected and information that an operation such as a zoom or pan was performed on the camera, and selecting a section equal to or larger than a threshold value.

However, in the method of International Publication No. 2005/086478, in a case where a walking object is being followed and shot by the photographer, selecting a section equal to or larger than the threshold value may result in a “tooth gap” since an evaluation value for a walking section and an evaluation value for a section in which the object is detected are totaled. In the case of following and shooting the object, it can be presumed that the shooting is intentional, but if the object turns their back to the photographer, the face of the object cannot be detected, and only a section in which the object faces the photographer is selected. When the threshold value is lowered in order to select a section in which an object is not facing the photographer, the entire walking section is selected regardless of whether or not an object is detected and a section thought to be shot unintentionally will be selected.

### SUMMARY OF THE INVENTION

The present invention provides a technique for specifying a frame section captured intentionally from a moving image.

According to the first aspect of the present invention, there is provided an image processing apparatus comprising: a specifying unit configured to specify in a moving image, as a motion section, a frame section including a plurality of consecutive frames related to a motion of a photographer of the moving image; an obtaining unit configured to obtain a ratio of frames in which a specific object is detected from among the plurality of frames forming the motion section; and a determining unit configured to determine, from one or more motion sections specified from the moving image by the specifying unit, based on the ratio obtained by the obtaining unit for each of the one or more motion sections, a motion section to be extracted as a highlight.

According to the second aspect of the present invention, there is provided an image processing method performed by an image processing apparatus, the method comprising: in a moving image, specifying, as a motion section, a frame section including a plurality of consecutive frames related to a motion of a photographer of the moving image; obtaining a ratio of frames in which a specific object is detected from among the plurality of frames forming the motion section; and determining, from one or more motion sections specified from the moving image, based on the ratio obtained for each of the one or more motion sections, a motion section to be extracted as a highlight.

According to the third aspect of the present invention, there is provided a non-transitory computer-readable storage medium storing a computer program for causing a computer to function as: a specifying unit configured to specify in a moving image, as a motion section, a frame section including a plurality of consecutive frames related to a motion of a photographer of the moving image; an obtaining unit configured to obtain a ratio of frames in which a specific object is detected from among the plurality of frames forming the motion section; and a determining unit configured to determine, from one or more motion sections specified from the moving image by the specifying unit, based on the ratio obtained by the obtaining unit for each of the one or more motion sections, a motion section to be extracted as a highlight.

Further features of the present invention will become apparent from the following description of exemplary embodiments (with reference to the attached drawings).

### BRIEF DESCRIPTION OF THE DRAWINGS

FIG. 1 is a block diagram illustrating an example of a hardware configuration of an image processing apparatus.

FIG. 2 is a block diagram illustrating an example of a functional configuration of an image processing apparatus.

FIG. 3 is a view illustrating a configuration example of a frame table.

FIG. 4 is a view illustrating an exemplary configuration of a motion section table.

FIG. 5 is a view illustrating a configuration example of a highlight section table.

FIG. 6 is a flowchart illustrating an operation of the image processing apparatus.

FIGS. 7A and 7B are views for describing a second embodiment.

FIG. 8 is a block diagram illustrating an example of a functional configuration of an image processing apparatus.

FIG. 9 is a view illustrating a configuration example of a concentrated section table.

FIG. 10 is a view illustrating a configuration example of a highlight section table.

FIG. 11 is flowchart illustrating an operation of the image processing apparatus.

FIG. 12 is a block diagram illustrating an example of a functional configuration of an image processing apparatus.

FIG. 13 is a view illustrating a configuration example of a frame table.

FIG. 14 is a view illustrating a configuration example of a highlight section table.

FIG. 15 is a flowchart illustrating an operation of the image processing apparatus.

FIG. 16 is a view illustrating a configuration example of a motion section table.

FIG. 17A is a flowchart illustrating an operation of the image processing apparatus.

FIG. 17B is a flowchart illustrating an operation of the image processing apparatus.

FIG. 18 is a view illustrating a configuration example of a highlight section table.

### DESCRIPTION OF THE EMBODIMENTS

Embodiments of the present invention are described below with reference to the accompanying drawings. Note that embodiments described below merely illustrate examples of specific implementations the present invention, and are only specific embodiments of a configuration defined in the scope of the claims.

### First Embodiment

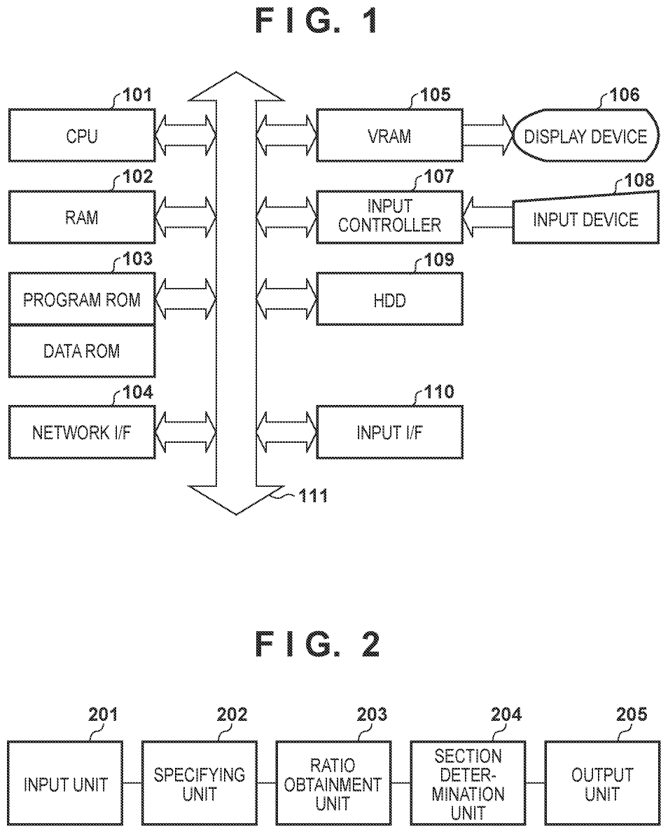

In a moving image, an image processing apparatus according to the present embodiment specifies, as a motion section, a frame section associated with motion of a photographer in the moving image, and determines a motion section to be used as a highlight (highlight section) from among the specified motion sections. The image processing apparatus generates and outputs a moving image in which the highlight sections are connected. The generated moving image has a shorter playback time than the original moving image. Also, the “object” referred to in the following embodiments is an organism having a face, and at least may be a person. However, in the case of “detecting an object from an image” hereinafter, what is actually detected is a “face region” including a feature amount of a face. In relation thereto, hereinafter, a portion of “face” of a person who is the object may be referred to as an “object” or a “specific object”. First, an example of a hardware configuration of the image processing apparatus according to the present embodiment will be described with reference to the block diagram of FIG. 1.

A CPU 101 executes various processes using computer programs and data stored in a RAM 102 and a ROM 103. As a result, the CPU 101 controls the operation of the entire image processing apparatus, and executes or controls the processes described later as being performed by the image processing apparatus.

The RAM 102 has areas for storing computer programs and data loaded from the ROM 103 and an HDD (hard disk drive) 109 and data received from the outside via a network I/F (interface) 104 and an input I/F 110. Furthermore, the RAM 102 has a work area used when the CPU 101 executes various processes. In this manner, the RAM 102 can appropriately provide various areas.

The ROM 103 has a program ROM in which a computer program such as a boot program of the image processing apparatus is stored, and a data ROM in which data such as setting data of the image processing apparatus is stored.

The network I/F 104 is a communication interface for performing data communication with external devices via wired and/or wireless networks such as LAN and the Internet.

A VRAM 105 is a memory for writing images and characters to be displayed on a display device 106, and this writing is performed by the CPU 101. The display device 106 is configured by a liquid crystal screen or a touch panel screen, and displays images or characters based on data written in the VRAM 105. Note that the display device 106 may be a projection device such as a projector for projecting images or characters written in the VRAM 105.

An input controller 107 notifies the CPU 101 of an instruction input from an input device 108. The input device 108 is a user interface such as a keyboard, a mouse, a touch panel, or a remote control, and can input various instructions to the CPU 101 via the input controller 107 by operation by a user.

The HDD 109 stores an OS (operating system) and computer programs and data for causing the CPU 101 to execute or control processes (to be described later) to be performed by the image processing apparatus. Data stored in the HDD 109 includes data described as known information in the following description. Computer programs and data stored in the HDD 109 are loaded into the RAM 102 as appropriate in accordance with control by the CPU 101, and are processed by the CPU 101. Note that the HDD 109 may be used instead of the ROM 103.

The input I/F 110 includes an interface for connecting a drive device for reading and writing information to a recording medium, such as a CD(DVD)-ROM drive or a memory card drive, and an interface for connecting an image capturing device for capturing a moving image.

The moving image to be processed by the image processing apparatus may be a moving image stored in the HDD 109, or may be a moving image received from an external device via the network I/F 104. Also, the moving image to be processed by the image processing apparatus may be a moving image inputted from an image capturing device or a drive device via the input I/F 110.

Each of the CPU 101, the RAM 102, the ROM 103, the network I/F 104, the VRAM 105, the input controller 107, the HDD 109, and the input I/F 110 is connected to an input/output bus 111. The input/output bus 111 is an input/output bus (an address bus, a data bus, and a control bus) that connects with each unit (the CPU 101, the RAM 102, the ROM 103, the network I/F 104, the VRAM 105, the input controller 107, the HDD 109, and the input I/F 110).

The image processing apparatus according to the present embodiment may be a computer device such as a PC (personal computer), a tablet-type terminal device, or a smart phone, or may be a device incorporated in an image capturing device for capturing a moving image.

Next, an example of a functional configuration of the image processing apparatus according to the present embodiment is described with reference to the block diagram of FIG. 2. Hereinafter, although each functional unit in FIG. 2 is described as the agent of the process, in reality, the functions of each functional unit are realized by the CPU 101 executing computer programs for causing the CPU 101 to realize the functions of each functional unit. Note that each functional unit illustrated in FIG. 2 may be implemented by hardware.

An input unit 201 obtains a moving image from the HDD 109, the network I/F 104, the input I/F 110, or the like. Frame information (metadata) attached to the image of each frame constituting the moving image is collected, and a table (frame table) in which the collected frame information is registered is created.

The image capturing device that captures the moving image detects a region (face region) including the face of an object from an image of each frame captured. When a face region is detected from an image, image coordinates (X, Y, W, H) of the face region in the image are attached to the image. Here, X and Y represent the X coordinate and Y coordinate of the center of the face region respectively (the origin is the upper left corner of the image), W represents the width of the face region, and H represents the height of the face region. In the present embodiment, X, Y, W, and H represent the X coordinate and Y coordinate of the center of the face region, the width of the face region, and the height of the face region, respectively, when the height and width of the image are set to 1.

In addition, the image capturing device attaches angular velocity in a pitch direction measured by a gyro sensor (mounted on the image capturing device), at the time of capturing an image, to the image of each captured frame. Regarding a value of the angular velocity in the pitch direction, the positive and negative signs indicate a vertical direction, and the larger the value, the larger a change in posture detected by the gyro sensor.

That is, in the image of each frame constituting the moving image, frame information of the image in which a face region is detected includes the image coordinates of the face region and the angular velocity in the pitch direction. Also, in the image of each frame constituting the moving image, the frame information of the image in which the face region is detected includes the angular velocity in the pitch direction without including the image coordinates of the face region.

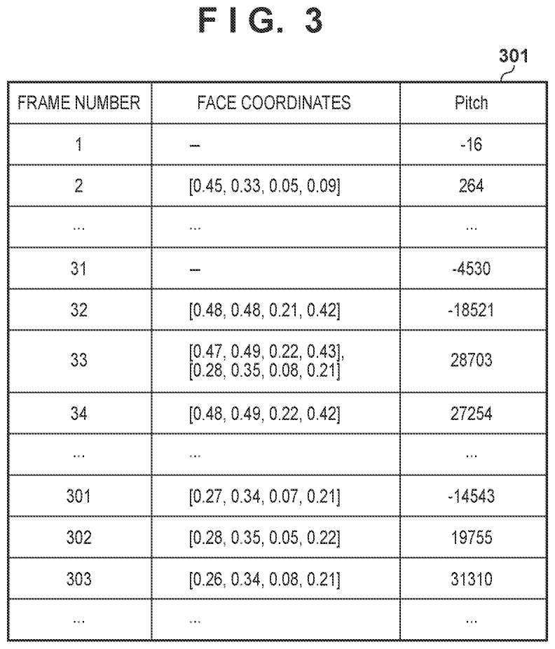

The input unit 201 registers frame information attached to the image of each frame in a frame table in association with the number of the frame. FIG. 3 illustrates an example of a configuration of the frame table according to the present embodiment.

In a frame table 301 of FIG. 3, “frame number” is the number of each frame in the moving image. The “frame number” of a head frame in the moving image is “1”, and the “frame number” of an f-th frame (f is a natural number) from the start of the moving image is “f”. “Face coordinates” are the image coordinates of the face region in the image, and the “Pitch” is the angular velocity in the pitch direction at the time of capturing the image.

In the example of FIG. 3, the frame information including the image coordinates (0.45, 0.33, 0.05, 0.09) of the face region and the angular velocity in the pitch direction “264” is attached to the image of the second frame (frame with the frame number “2”) from the head of the moving image. Therefore, the input unit 201 registers the frame number “2”, the image coordinates (0.45, 0.33, 0.05, 0.09) of the face region, and the angular velocity “264” in the pitch direction to the same row in association with each other.

On the other hand, in the example of FIG. 3, frame information including the angular velocity “−4530” in the pitch direction is attached to the image of the 31st frame from the head of the moving image (frame having the frame number of “31”), without including image coordinates of a face region. Accordingly, the input unit 201 registers the frame number “31”, information indicating that the image coordinates of a face region do not exist (“−” in FIG. 3), and the angular velocity “−4530” in the pitch direction to the same row in association with each other.

In this manner, the input unit 201 registers the number of each frame in the table in association with the frame information attached to the image of the frame. So, the configuration of the table is not limited to the configuration illustrated in FIG. 3 as long as the table is capable of registering such a correspondence relationship.

Also, a frame table for managing such frame information is generated for each moving image. When a plurality of face regions are detected from an image of one frame, the frame information of the image may include the image coordinates of the plurality of face regions, and in this case, the image coordinates of the plurality of face regions are registered in the frame table in association with the frame number of the frame.

In the moving image, a specifying unit 202 specifies a frame section associated with the motion of the photographer of the moving image as a motion section. In the present embodiment, as a “frame section associated with the motion of the photographer of the moving image”, a frame section (section with motion) in which the photographer is shooting while walking is specified as a motion section.

There are various methods for specifying a motion section, and the method is not limited to a specific method. For example, the specifying unit 202 references the frame table 301 in FIG. 3, and sets a frame section in which an absolute value of the angular velocity in the pitch direction is equal to or larger than a threshold value as a motion section. Note, since a method for specifying a motion section in a moving image is known, further description thereof is omitted.

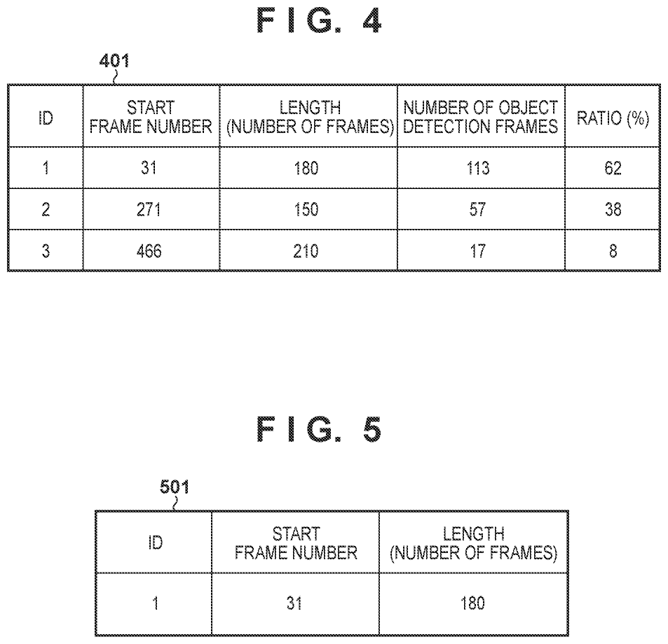

The specifying unit 202 registers, for each motion section specified from the moving image, identification information (ID) of the motion section, the start frame (head frame) number of the motion section, and the length (number of frames) of the motion section to the motion section table in association with each other. FIG. 4 illustrates an example of a configuration of a motion section table.

In a motion section table 401, “ID” is identification information unique to each motion section, “start frame number” is the frame number of the start frame of the motion section, and “length (number of frames)” is the length (number of frames) of the motion section. In the example of FIG. 4, for the second motion section from the head of the moving image, the frame number “31” of the start frame of the motion section and the length (number of frames) “180” of the motion section are registered in association with the ID “2” of the motion section. A “number of object detection frames” and “ratio (%)” in the motion section table 401 of FIG. 4 is described later.

A ratio obtainment unit 203 references the frame table 301 and the motion section table 401, counts, for each motion section, the number of frames in which a face was detected in the motion section (the number of object detection frames), and obtains a ratio of the number of object detection frames to the number of frames in the motion section.

For example, when calculating the ratio of the number of object detection frames for a motion section with ID=1, the ratio obtainment unit 203 firstly obtains the start frame number “31” and the length (number of frames) “180” corresponding to ID=1 from the motion section table 401. For the frame table 301 of FIG. 3, the ratio obtainment unit 203 counts the number of frame numbers for which the image coordinates of the face region are registered from among the frame numbers “31” to “211 (=31+180)” as the number of object detection frames in the motion section of ID=1. That is, for the frame table 301, the ratio obtainment unit 203 counts, as the number of object detection frames in the motion section with ID=1, the number of frames in which the image coordinates of the face region are registered from among the frames within the section of 180 frames with the 31st frame as the head. Then, the ratio obtainment unit 203 registers the number of object detection frames counted for the motion section of ID=1 in the motion section table 401 in association with ID=1. In the example of FIG. 4, “113” is registered as the “number of object detection frames” corresponding to the motion section of ID=1.

Next, the ratio obtainment unit 203 obtains the number of object detection frames “113” corresponding to ID=1 from the motion section table 401. Then, the ratio obtainment unit 203 obtains a ratio “62%” of the number of object detection frames “113” corresponding to ID=1 to the length (number of frames) “180” corresponding to ID=1. Then, the ratio obtainment unit 203 registers the obtained ratio “62%” in the motion section table 401 as the “ratio (%)” corresponding to ID=1.

In this manner, the ratio obtainment unit 203 counts the number of object detection frames for each ID registered in the motion section table 401, and registers the counted number of object detection frames in the motion section table 401 in association with the ID. Then, for each ID registered in the motion section table 401, the ratio obtainment unit 203 obtains the ratio of the number of object detection frames to the length (number of frames) corresponding to the ID, and registers the obtained ratio in the motion section table 401 in association with the ID. The motion section table 401 is generated for each moving image. In the present embodiment, the ratio obtained by the ratio obtainment unit 203 means a ratio of “a frame of a timing at which the object faces the photographer (imaging device) in a frame section in which the photographer is moving while shooting”. As a concrete example, this corresponds to the frequency at which a child looks back in a situation in which a parent (photographer) is shooting a moving image while following a child (object) and the child looks back occasionally.

A section determination unit 204 specifies an ID corresponding to a ratio equal to or larger than the threshold value in the motion section table 401 of FIG. 4, and registers the specified ID and the start frame number and the length (number of frames) corresponding to the specified ID to the highlight section table in association with each other. FIG. 5 illustrates an example of a configuration of a highlight section table. The threshold value used here designates the height of a frequency at which a face of an object is captured in a case where a frame section in which a photographer is shooting while moving is extracted as a highlight section. If the threshold value is lower, a target section is more easily extracted as a highlight section even if the frequency of the object looking back is low. On the other hand, if the threshold value is higher, a target section tends not to be extracted as a highlight section unless the object is looking back at a high frequency. For example, if a parent who is the photographer is moving and a child who is moving in the same way does not look back, it is more likely that movement toward some target rather than the shooting of a moving image is being prioritized, as compared with a case where the child looks back frequently. On the other hand, when the child looks back frequently, the child who is the object is aware that a moving image is being shot or that the parent is following, and there is a high possibility that their facial expressions or utterances are meaningful to the parent who is the photographer. Therefore, in the present embodiment, by setting an appropriate threshold value, a section having a high possibility of particularly meaning to the photographer is extracted from “a frame section in which a photographer is moving while shooting”.

In FIG. 5, the threshold value is set to 60%. In the motion section table 401 of FIG. 4, the ID corresponding to the ratio “62%” is larger than the threshold value “60%” is “1”. For this reason, the start frame number “31” and the length (number of frames) “180” corresponding to ID=1 are registered in a highlight section table 501 in association with ID=1. The highlight section table 501 is generated for each moving image. That is, the section determination unit 204 determines, as the highlight section, a motion section in which the above described ratio is equal to or larger than the threshold value from among motion sections specified by the specifying unit 202. Note, the value of the threshold value may be adjusted to an appropriate value by a designer at the design stage of the image processing apparatus or by a user after shipment.

For each ID registered in the highlight section table, an output unit 205 obtains, from the moving image, a frame group in a frame section (highlight section) of the length (number of frames) corresponding to the ID, from the frame of the start frame number corresponding to the ID. Then, the output unit 205 generates and outputs a moving image (highlight moving image) in which a group of frames of each highlight section is connected. Although the connection order of the frame groups of each highlight section is not limited to a specific order, for example, the frame groups are connected so that the highlight sections are arranged in order of decreasing ID.

The destination to which the output unit 205 outputs is not limited to a specific output destination. For example, the output unit 205 may upload a highlight moving image to a server, in which case the uploaded highlight moving image can be browsed by a device which can access the server.

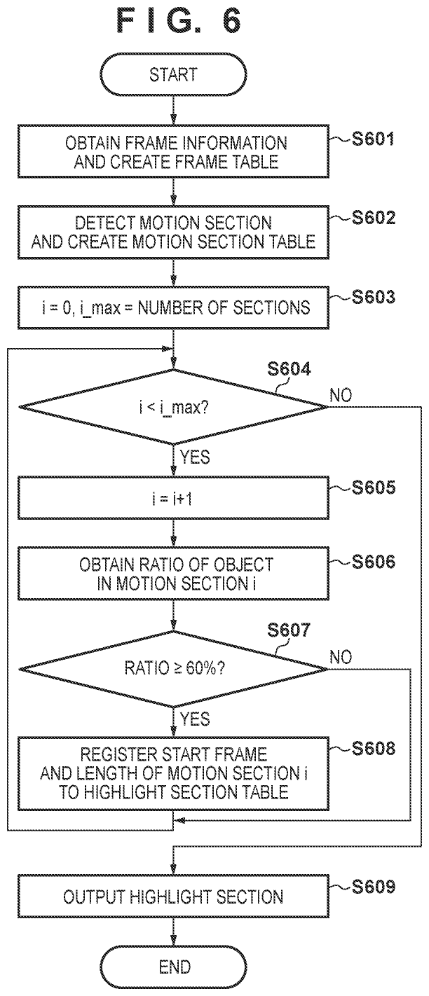

The operation of the image processing apparatus described above is described in accordance with the flowchart of FIG. 6. In step S601, the input unit 201 obtains a moving image, collects frame information attached to the image of each frame constituting the moving image, and registers the frame information collected for the frames to a frame table in association with the number of the frame.

In step S602, the specifying unit 202 specifies motion sections from the moving image. As described above, a known method (for example, the method described in Japanese Patent Laid-Open No. 2011-164227) may be employed as a method for specifying a “walking section” to be a motion section from a moving image. Then, the specifying unit 202, for each motion section specified from the moving image, registers to the motion section table an ID of the motion section, the number of the start frame of the motion section, and the length of the motion section in association with each other.

In step S603, the ratio obtainment unit 203 initializes a variable i used in the following process to 0, and sets a variable i_max to the number of motion sections (the number of sections) specified in step S602.

In step S604, the ratio obtainment unit 203 determines whether or not i<i_max. As a result of this determination, if i<i_max, the process proceeds to step S605, and if i≥i_max, the process proceeds to step S609.

In step S605, the ratio obtainment unit 203 increments the value of the variable i by one. Then, in step S606, the ratio obtainment unit 203 obtains the “ratio of the number of object detection frames to the number of frames of the motion section i” of the motion section (motion section i) corresponding to ID=i in the motion section table.

In step S607, the section determination unit 204 determines whether or not the ratio obtained in step S606 (the ratio calculated for the motion section i) is equal to or larger than the threshold value “60%”. As a result of this determination, if the ratio obtained in step S606 is equal to or larger than the threshold value “60%”, the process proceeds to step S608, and if the ratio obtained in step S606 is less than the threshold value “60%”, the process proceeds to step S604.

In step S608, the section determination unit 204 registers the ID “i” and the start frame number and the length (number of frames) corresponding to the ID=i to the highlight section table in association with each other.

In in step S609, for each ID registered in the highlight section table, the output unit 205 obtains, from the moving image, a frame group in a highlight section of the length (number of frames) corresponding to the ID from the frame of the start frame number corresponding to the ID. Then, the output unit 205 generates and outputs a moving image (highlight moving image) in which a group of frames of each highlight section are connected.

Note, in the present embodiment, the ratio obtained by the ratio obtainment unit 203 (step S606) is not the ratio of a section in which the object continues to look at the image capturing device. That is, in a case where a motion of looking back and then forward is repeated by an object, a ratio is calculated of sections in which intermittently occurring frames in which a face is detected are totaled from among all the moving sections including such a repetition. Therefore, if the ratio exceeds a predetermined threshold value, even if a frame in which a face is captured and a frame in which a face is not captured are repeatedly generated at irregular intervals, all of the “sections in which the photographer is moving” are extracted as highlight sections. As described above, according to the present embodiment, it becomes possible to select, as a highlight section, a section even in a scene in which the object is not facing the imaging plane, and it is possible to select, as a highlight section, a section in which the photographer is following and shooting the object while walking without a tooth gap.

In addition, since, compared to a case in which a section being shot while walking is shot while the photographer is stationary, there is a possibility that the measured value of the gyro sensor will fluctuate and there will be camera shake in terms of image quality, such a section is commonly a candidate for exclusion from the highlight section; however such a section can be actively selected.

In the first embodiment, a highlight moving image in which groups of frames of each highlight section are connected is generated, but the group of frames of each highlight section may be used in any manner. For example, an image of an arbitrary frame in each highlight section may be used to create other content such as a photo book.

In the first embodiment, the threshold value is set to 60%, the threshold value is not limited to this value. If a value of the ratio for selecting a highlight section is empirically or statistically calculated, the value may be used as the threshold value.

Also, when a motion section cannot be specified from the moving image, or when all the ratios registered in the motion section table are less than the threshold value, nothing is registered in the highlight section table, and as a result, a highlight moving image is not output. In such a case, the output unit 205 may transmit a message indicating that a highlight moving image cannot be output, or may prompt reprocessing by another processing method including manual processing.

Note, the method for specifying a frame section in which the photographer is shooting while walking is not limited to the method of using the angular velocity in the pitch direction of the gyro sensor. For example, the method for specifying a frame section in which the photographer is shooting while walking may be a method in which an angular velocity in the yaw direction is used or a method in which a value obtained by combining an angular velocity in the pitch direction and an angular velocity in the yaw direction is used. In addition to the method that uses the angular velocity measured by the gyro sensor, a method that uses angular acceleration measured by the gyro sensor, or another sensor may be used for specifying a frame section, such as an acceleration sensor, for example.

Furthermore, a frame section in which the photographer is shooting while walking may be specified by image processing, and for example, a frame section in which the photographer is shooting while walking may be specified from the direction of motion vectors generated by block matching between frames. When an object is being followed, motion vectors appear in a radial direction from the center of the image, and when walking in parallel with the object, motion vectors appear in a horizontal direction over the entire background region other than the object. Accordingly, from these directions, a frame section in which the photographer is shooting while walking is determined.

In the first embodiment, a frame section in which the photographer is shooting while walking is used as a motion section. However, a section of a zoom (zoom section) in which the focal length of the image capturing device is changed in order to enlarge a distant object or a section of a “follow pan” (follow pan section) in which the direction of the image capturing device is changed in order to keep tracking an object may also be used as a motion section.

For detection of a zoom section, a method of detecting, as a zoom section, a frame section in which a user operates a button or a lever in order to cause the image capturing device to perform a zoom operation, or a method of making a frame section in which a temporal change in focal length is detected be a zoom section may be used. Alternatively, the zoom section may be detected by an image analysis method using motion vectors in an image.

The method of detecting a follow pan section may be a method using a value measured by a gyro sensor as in the technique disclosed in, for example, Japanese Patent No. 3186219, or may be a method of image analysis using motion vectors.

Also, in the first embodiment, a face, as an object, is detected by face detection processing, but the present invention is not limited to this, and the face may be detected by another method, and the object is not be limited to being a face. For example, a person may be detected as an object by using a person detection process for detecting the shape of a person. At this time, since a detection rate changes depending on the detection method, the threshold value for the section object detection ratio may be changed, and when the detection rate is high, the threshold value may be increased, and when the detection rate is low, the threshold value may be decreased.

Also, in the first embodiment, when the number of frames in which a face is detected in the motion section is counted as the number of object detection frames, regardless of the position or size of the face region within an image, the number is counted if a face region is detected from the image. That is, the number of frame numbers in which the image coordinates of a face region are registered is counted as the number of object detection frames. However, the number of frame numbers in which “the image coordinates of a face region satisfying a defined condition” are registered may be counted as the number of object detection frames.

For example, the number of frame numbers for which face region image coordinates (X, Y, W, H) whose X and Y are between 0.1 to 0.9 (image coordinates in a defined range) are registered may be counted as the number of object detection frames. Also, for example, the number of frame numbers for which face region image coordinates (X, Y, W, H) whose W and H are 0.01 or more (a size in a defined range) are registered may be counted as the number of object detection frames. As described above, an image in which the face region is positioned in a peripheral portion or an image in which the ratio of the face region is relatively small can be excluded from of the number of object detection frames count. In such a case, since the number of object detection frames becomes relatively smaller than that of the first embodiment, the threshold value to be compared with the number of object detection frames may also be made smaller than that of the first embodiment.

Further, in the first embodiment, object detection processing is used, but a person recognition processing method in which a person can be identified may be used, and configuration may be such that an image in which only a registered person (an object of a specific class), for example one's own child, is detected is counted in the number of object detection frames. As a result, by not using a different object that unintentionally appears during shooting when obtaining the ratio, an erroneous selection of a highlight is reduced. At this time, since the number of object detection frames becomes relatively smaller than that of the first embodiment, the threshold value to be compared with the number of object detection frames may also be made smaller than that of the first embodiment.

### Second Embodiment

In each of the following embodiments and each modification including the present embodiment, differences from the first embodiment are described, and what is not specifically mentioned below is assumed to be the same as in the first embodiment. In the first embodiment, a section in which the photographer is walking is detected as an example of a motion section, and the ratio of the frames in which an object is detected with respect to the detected motion section is obtained.

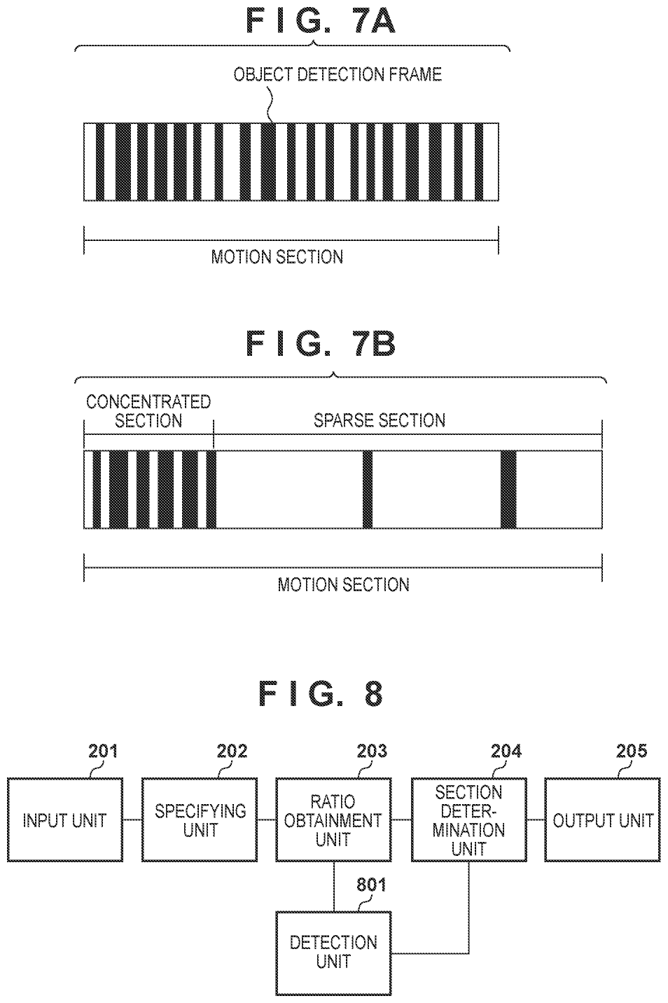

In the motion section illustrated in FIG. 7A (a black portion represents frames in which an object is detected and a white portion represents frames in which an object is not detected), the ratio of frames in which an object is detected in the motion section is relatively high, and therefore, such a motion section is easily selected as a highlight section.

However, in a case where a walking section is long or the like, as illustrated in the FIG. 7B, there is a possibility that a section (concentrated section) in which the frames (black portion) in which an object is detected will be concentrated and a section (sparse section) in which such frames are not concentrated occurs. Such a motion section may not be selected as a highlight section because the ratio of frames in which an object is detected is relatively low in the motion section.

In the present embodiment, even if the ratio of the frames in which the object is detected in the motion section is less than the threshold value, if a concentrated section exists in the motion section, the concentrated section is selected as a highlight section.

Next, an example of a functional configuration of the image processing apparatus according to the present embodiment is described with reference to the block diagram of FIG. 8. The configuration illustrated in FIG. 8 is obtained by adding a detection unit 801 to the configuration of FIG. 2. The detection unit 801 specifies a start frame number and a length (number of frames) corresponding to a ratio of less than a threshold value in the motion section table 401 of FIG. 4, and determines whether or not there is a concentrated section within the frame section of the length (number of frames) from the frame of the start frame number.

Operation of the image processing apparatus according to the present embodiment will be described in accordance with the flowchart of FIG. 11. In FIG. 11, the same processing steps as the processing steps illustrated in FIG. 6 are denoted by the same step numbers, and description corresponding to those processing steps is omitted.

In step S1101, the section determination unit 204 determines whether or not the ratio calculated in step S606 (the ratio obtained for the motion section i) is equal to or larger than the threshold value “60%”. If the result of this determination is that the ratio obtained in step S606 is equal to or larger than the threshold value “60%”, the process proceeds to step S608, and if the ratio obtained in step S606 is less than the threshold value “60%”, the process proceeds to step S1103.

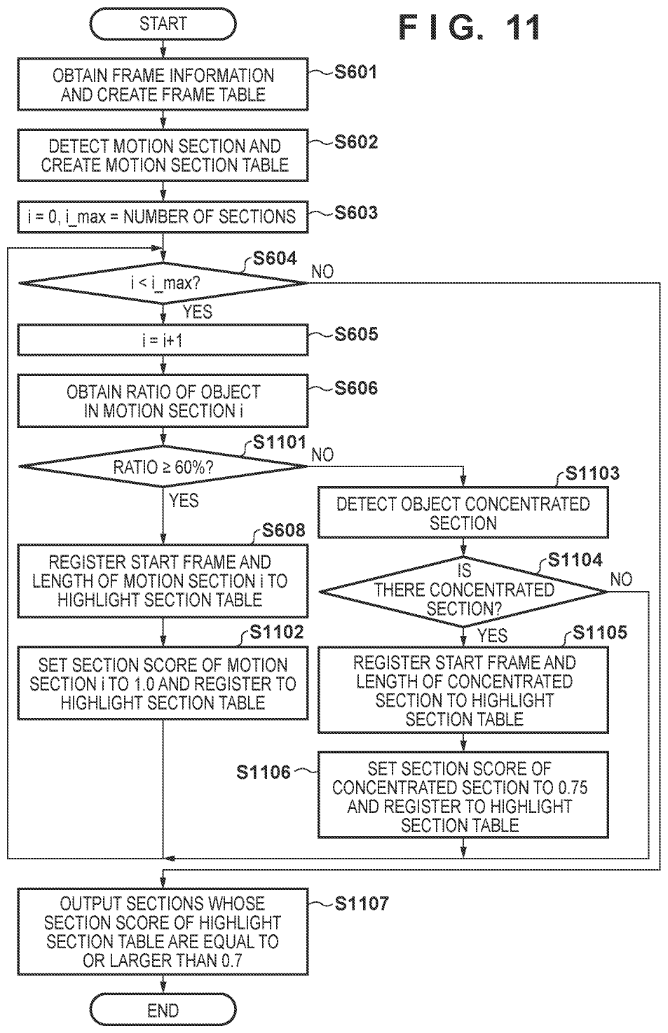

In step S1102, the section determination unit 204 registers the ID “i” and a section score “1.0” corresponding to the motion section i to the highlight section table in association with each other. FIG. 10 illustrates an example of a configuration of a highlight section table according to the present embodiment.

In a highlight section table 1001 of FIG. 10, the start frame number, the length (number of frames), and the section score corresponding to ID=1 are all for the motion section of ID=1. In the highlight section table 1001, “31” is registered as the start frame number corresponding to ID=1, “180” is registered as the length (number of frames) corresponding to ID=1, and “1.0” is registered as the section score corresponding to ID=1.

In step S1103, the detection unit 801 specifies the start frame number and the length (number of frames) corresponding to ID=i from the motion section table, and determines whether or not there is a concentrated section in the frame section (motion section i) of the length (number of frames) from the frame of the start frame number.

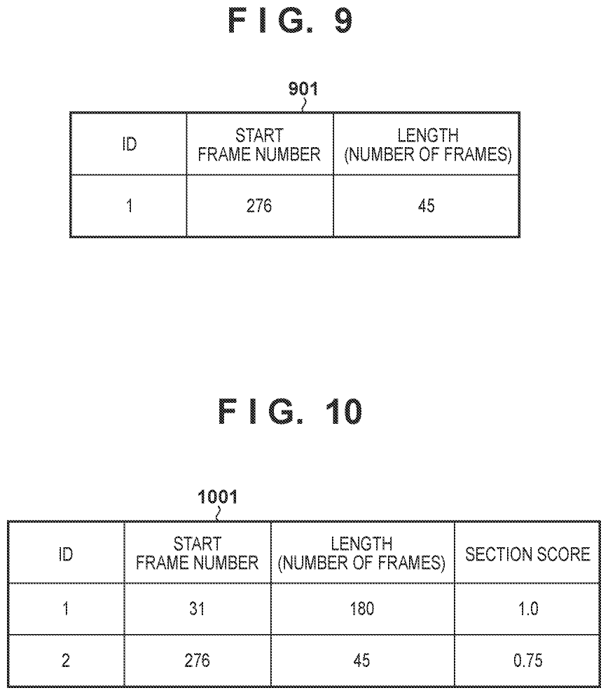

There are various methods for determining whether or not a concentrated section exists in the motion section i, and the method is not limited to a specific method. For example, a window function may be used to detect a section having a value equal to or larger than a predetermined value in the motion section i as a concentrated section. Note, the number of concentrated sections detected from the motion section i may be plural. In such a case, the detection unit 801 creates a concentrated section table in which ID=i, the start frame number of the concentrated section, and the number of frames of the concentrated section (length (the number of frames)) are registered. FIG. 9 illustrates an example of a configuration of the concentrated section table. In a concentrated section table 901 of FIG. 9, the start frame number “276” and the length (number of frames) “45” are registered in association with ID=1.

In step S1104, the detection unit 801 determines whether or not a concentrated section has been detected from the motion section i. As a result of this determination, when a concentrated section is detected in the motion section i, the process proceeds to step S1105, and when a concentrated section is not detected in the motion section i, the process proceeds to step S604.

In step S1105, the detection unit 801 registers the ID=i, the start frame number of the concentrated section, and the number of frames (length (number of frames)) of the concentrated section to the highlight section table 1001 in association with each other.

In step S1106, the detection unit 801 registers the ID=i and a section score “0.75” of the concentrated section in the highlight section table 1001 in association with each other. In the highlight section table 1001 of FIG. 10, the start frame number, the length (number of frames), and the section score corresponding to ID=2 are all for the concentrated section of ID=2. In the highlight section table 1001, “45” is registered as the start frame number corresponding to ID=2, “276” is registered as the length (number of frames) corresponding to ID=2, and “0.75” is registered as the section score corresponding to ID=2. Here, the value of the section score is normalized to be within 0.0 to 1.0, and a section having a higher value of the section score is a section more suitable for the highlight section.

In step S1107, the output unit 205 specifies, as the target ID, an ID whose corresponding section score is equal to or larger than the threshold value “0.7” from among each of the IDs registered in the highlight section table 1001. Then, from the frame of the start frame number corresponding to a target ID, the output unit 205 obtains, from the moving image, a frame group in the highlight section of the length (number of frames) corresponding to the target ID. Then, the output unit 205 generates and outputs a moving image (highlight moving image) in which the groups of frames of each highlight section are connected.

As described above, according to the present embodiment, even when the ratio of the frames in which the object is detected in a motion section is low, a section in which the frames in which the object is detected are concentrated can be selected as a highlight section. Therefore, also in the second embodiment, it is possible to extract, as a highlight section, a section having a high possibility of being particularly meaningful to the photographer in a “frame section in which the photographer is moving while shooting”.

<Variation>

The threshold value used in step S1107 is not limited to 0.7, and the number of motion sections to be selected as highlight sections may be adjusted by adjusting this threshold value. By adjusting this threshold value, when the amount (length, time) of a highlight section is limited, it is possible to preferentially output, as a highlight section, motion section shaving a high section score, that is, sections intentionally shot by the photographer.

Based on experience, it is known the photographer is more likely to have intended to shoot a section in the case of selection of the entire motion section than a section in which the concentrated section is detected. Therefore, in the present embodiment, priority is given by setting the section score in a case of selection of the entire motion section to 1.0 and setting the section score of a concentrated section to 0.75, but these values are not limited, and other values may be used.

Also, in the second embodiment, although a motion section in which the ratio is less than the threshold value are targets in the processing for detection a concentrated section makes, a motion section in which the ratio is equal to or larger than the threshold value may be made a target. For example, there are cases in which, when the motion section is long, there is a long section whose distribution of frames in which an object is detected is sparse even though the ratio is high, and by detecting a concentrated section, the sparse section can be removed.

Furthermore, a section that is from the frame position that is defined number of frames towards the head of the moving image from the head frame position of a concentrated section as detected in the second embodiment and that is to a frame position defined number of frames towards the end of the moving image from the end frame position of the concentrated section may be used as the concentrated section. Thereby, the user can know what the situation was before the object appeared and can feel the afterglow after the object disappears, and so the value as a highlight section video is enhanced.

### Third Embodiment

In the second embodiment, a section score is attached to a section that is a candidate for a highlight section, and the highlight section is determined in accordance with the size of the value of the section score. However, there is a possibility that a section having a high section score but poor image quality will be selected as a highlight section.

In the present embodiment, to a section which is a highlight section candidate, an image quality score corresponding to the image quality of the section is attached in addition to the section score, and the highlight section is determined in accordance with the size of the value of the total score into which the section score and the image quality score of the section are added.

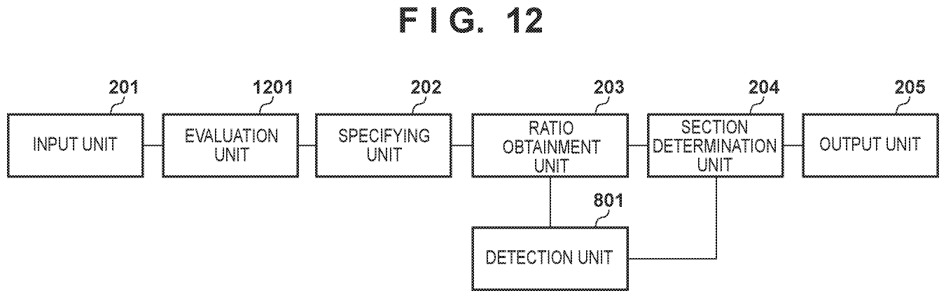

An example of a functional configuration of the image processing apparatus according to the present embodiment is described with reference to the block diagram of FIG. 12. The configuration illustrated in FIG. 12 is obtained by adding an evaluation unit 1201 to the configuration illustrated in FIG. 8.

The evaluation unit 1201 obtains an image quality score corresponding to the image quality of the images of each frame in the moving image input by the input unit 201. The image quality score is normalized to be within 0.0 to 0.8, and the higher the value, the higher the image quality. The image quality score may be any value as long as it is a value obtained by quantifying the image quality of an image, and is obtained by using the orientation, size, brightness, color vividness, degree of bokeh or blurring, and the like of a face in the image as in the method described in Japanese Patent Laid-Open No. 2014-75778, for example.

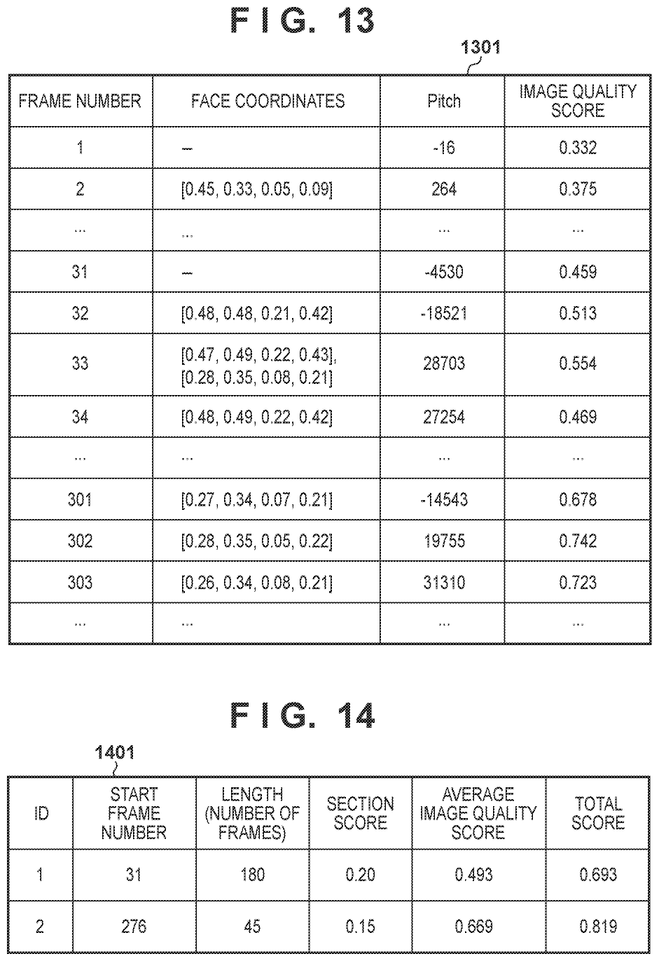

Then, the evaluation unit 1201 registers an image quality score of the image of each frame in the frame table in association with the frame number of the frame. FIG. 13 illustrates an example of a configuration of the frame table according to the present embodiment. A frame table 1301 illustrated in FIG. 13 is obtained by adding an item of an image quality score to the frame table 301 of FIG. 3. That is, the frame table 1301 is a table for managing frame numbers, face coordinates, Pitch, and image quality scores for each frame.

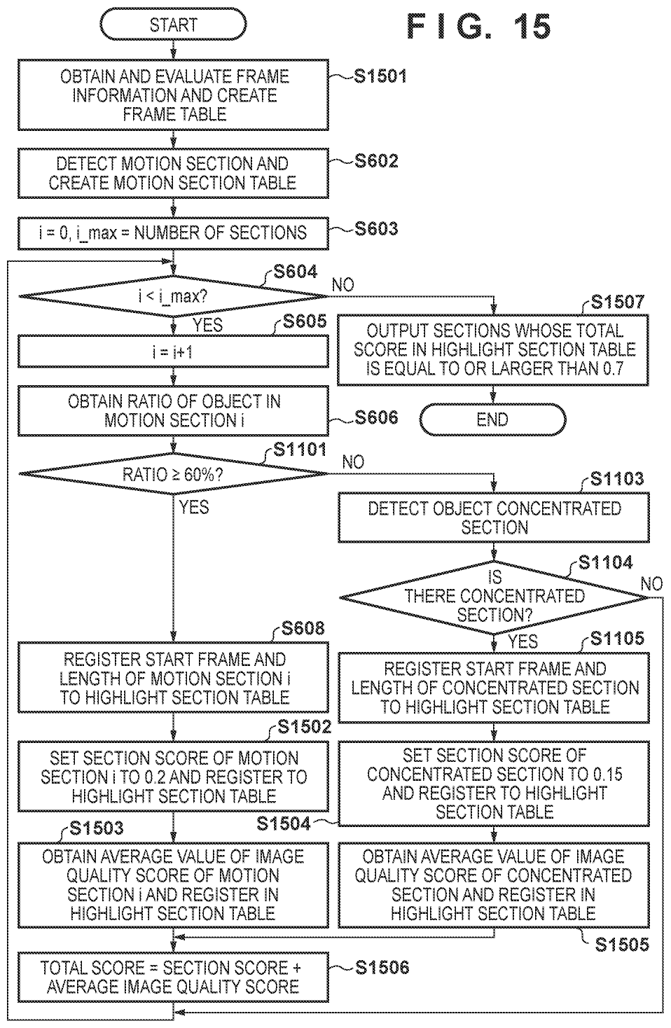

The section determination unit 204 registers an ID corresponding to a ratio equal to or larger than a threshold value in the motion section table, a start frame number and a length (number of frames) corresponding to the ID, a section score corresponding to the ID, an average image quality score in the motion section corresponding to the ID, and a total score corresponding to the ID to the highlight section table in association with each other. FIG. 14 illustrates an example of a configuration of a highlight section table according to the present embodiment. A highlight section table 1401 of FIG. 14 is obtained by adding the items of the average image quality score and the total score to the highlight section table 1001 of FIG. 10.

The section score of the present embodiment is normalized to be within 0.0 to 0.2. The average image quality score is an average value of the image quality scores of the image of each frame included in the motion section, and is normalized to be within 0.0 to 0.8 as described above. For example, the average image quality score of the motion section of ID=1 is the average value of the image quality scores of the images of each frame included in a frame section of a length of 180 frames where the image of the 31st frame is the head frame in the moving image, and is “0.493” in FIG. 14. The total score is a total value of the section score and the average image quality score, and for example, the total score corresponding to ID=1 is the total value “0.693” of the section score “0.20” corresponding to ID=1 and the average image quality score “0.493” corresponding to ID=1. Since the image quality score is normalized to be within 0.0 to 0.8 and the section score is normalized to be within 0.0 to 0.2, the total score according to the present embodiment is normalized to be within 0.0 to 1.0.

In addition to the start frame number, the length (number of frames), and the section score, the detection unit 801 registers the average value (average image quality score) of the image quality scores of the image of each frame in the concentrated section and the total value (total score) of the section score and the average image quality score to the highlight section table.

The operation of the image processing apparatus according to the present embodiment is described in accordance with the flowchart of FIG. 15. In FIG. 15, the same processing steps as the processing steps illustrated in FIGS. 6 and 11 are denoted by the same step numbers, and a description corresponding to the processing steps is omitted.

In step S1501, the input unit 201 obtains a moving image, collects frame information attached to the image of each frame constituting the moving image, and registers the frame information collected for the frames in a frame table in association with a number of the frame. The evaluation unit 1201 obtains the image quality score of each frame in the moving image input by the input unit 201, and registers the image quality score of the image of each frame in the frame table in association with the frame number of the frame.

In step S1502, the section determination unit 204 registers the ID “i” and a section score “0.2” corresponding to the motion section i to the highlight section table in association with each other. In step S1503, the section determination unit 204 obtains the average image quality score in the motion section i, and registers the obtained average image quality score to the highlight section table in association with the ID “i”.

In step S1504, the detection unit 801 registers the ID “i” and a section score “0.15” corresponding to a concentrated section in the motion section i to the highlight section table in association with each other.

In step S1505, the detection unit 801 obtains the average image quality score of the concentrated section within the motion section i, and registers the obtained average image quality score to the highlight section table in association with the ID “i”.

When the process proceeds from step S1503 to step S1506, the section determination unit 204 obtains total value of the section score corresponding to ID=i and the average image quality score corresponding to ID=i as the total score. Then, the section determination unit 204 registers the obtained total score in the highlight section table in association with ID=i.

On the other hand, when the process proceeds from step S1505 to step S1506, the detection unit 801 obtains the sum of the section score corresponding to ID=i and the average image quality score corresponding to ID=i as the total score. Then, the detection unit 801 registers the obtained total score in the highlight section table in association with ID=i.

In step S1507, the output unit 205 specifies, as the target ID, an ID whose corresponding total score is equal to or larger than the threshold value “0.7” among the IDs registered in the highlight section table. Then, from the frame of the start frame number corresponding to a target ID, the output unit 205 obtains, from the moving image, a frame group in the highlight section of the length (number of frames) corresponding to the target ID. Then, the output unit 205 generates and outputs a moving image (highlight moving image) in which the groups of frames of each highlight section are connected.

As described above, according to the present embodiment, by using the image quality score for which the frames are evaluated, it is possible to select a section with a good image quality as a highlight section from among the sections shot intentionally. Thus, for example, in the second embodiment, the section having the ID of 1 in the highlight section table is preferentially selected, but in the present embodiment, since the image quality score of the section having the ID of 2 is higher, that section is preferentially selected.

Note, in the present embodiment, the distribution of the maximum value (0.2) of the section score and the maximum value (0.8) of the average image quality score is set to 1:4 so that the highlight section can be preferentially selected based on the image quality, but the distribution is not limited to these values and may be different values. For example, when the image quality is not prioritized, the distribution of the image quality score may be lowered such that the maximum value of the section score is 0.8 and the maximum value of the image quality score is 0.2, or the distribution value may be empirically or statistically calculated.

### Fourth Embodiment

In the first embodiment, as an example of the motion section, an example of a “follow pan” in which an object is continuously followed while changing the orientation of the image capturing device was given. However, even in a case of a pan in which the orientation of the image capturing device is changed, in a case of a “snap pan” in which the speed of changing the orientation of the image capturing device is high and the object changes, there is a possibility that it is difficult to confirm the video during the pan. In this case, there is a higher possibility that sections before and after the snap pan (sections where an object is shot) are the sections which are shot intentionally rather than the video of the section where the pan is being performed. Therefore, in the present embodiment, the highlight section is specified based on the ratio of the number of detection frames of the object from the sections before and after the snap pan when a snap pan is detected.

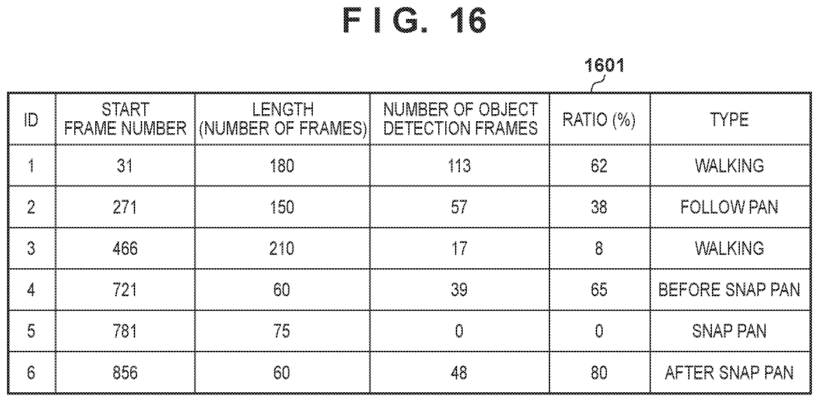

The image processing apparatus according to the present embodiment has the configuration illustrated in FIG. 8. In the present embodiment, a motion section table 1601 illustrated in FIG. 16 is generated. The motion section table 1601 of FIG. 16 is obtained by adding an item of a type of a motion section to the motion section table 401 of FIG. 4. The type of the motion section is specified by the specifying unit 202, and is “walking”, “follow pan”, “snap pan”, or the like.

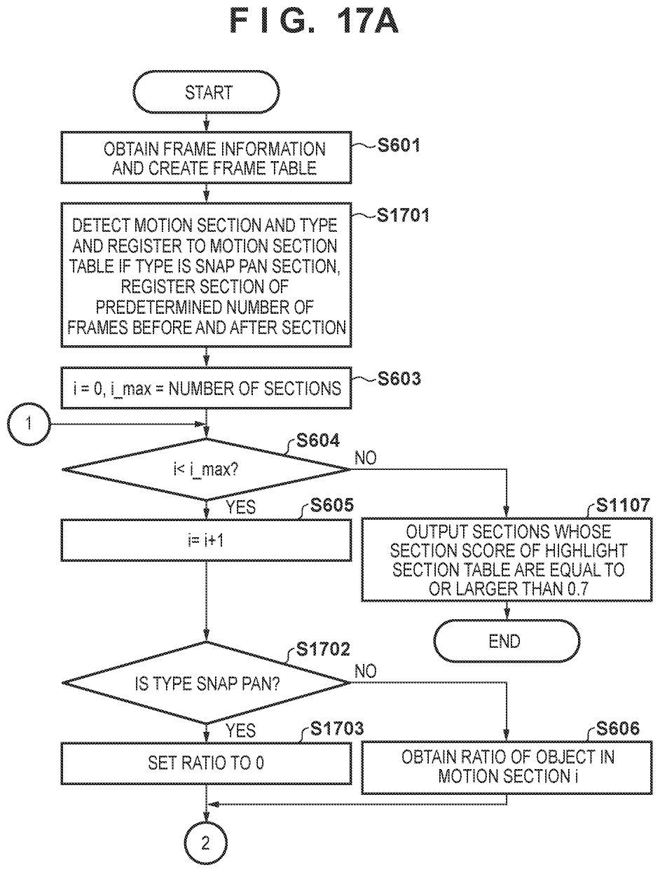

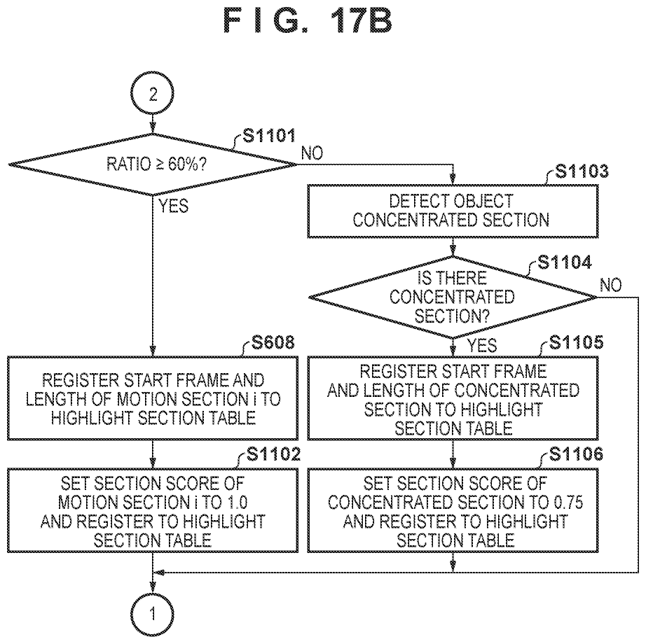

The operation of the image processing apparatus according to the present embodiment is described in accordance with the flowcharts of FIGS. 17A and 17B. In FIGS. 17A and 17B, the same processing steps as the processing steps illustrated in FIGS. 6 and 11 are denoted by the same step numbers, and a description corresponding to the processing steps is omitted.

In step S1701, the specifying unit 202 specifies a motion section in the moving image, and specifies the type of the specified motion section. The type of the motion section may be determined from the measured value of the gyro sensor or may be determined from the image. Also, the type of the motion section may be included in the frame information. Then, the specifying unit 202 registers, for each of the specified motion sections, the ID of the motion section, the number of the start frame of the motion section, the length of the motion section, and the type of the motion section to the motion section table 1601 in association with each other.

Note, the specifying unit 202 sets a section of 60 frames before and after the motion section (snap pan motion section) in which the type of the motion section is specified as a snap pan. Then, the specifying unit 202 registers, for the set sections, the ID of the section, the number of the start frame of the section, the length of the section, and the type of the section to the motion section table in association with each other.

The start frame number of a 60 frame section (preceding section) set before the snap pan motion section is a number obtained by subtracting 60 from the start frame number of the snap pan motion section; the length of the preceding section is 60; and the type of the preceding section is “before snap pan”. The start frame number of a 60 frame section (succeeding section) set after the snap pan motion section is a number obtained by adding the length of the snap pan motion section to the start frame number of the snap pan motion section; the length of the succeeding section is 60; and the type of the succeeding section is “after snap pan”.

In the example of FIG. 16, the motion section corresponding to ID=5 is a snap pan motion section, and “snap pan” is registered as the corresponding type. ID=4 is assigned to the preceding section of 60 frames set before the snap pan motion section, and “before snap pan” is registered as the corresponding type. On the other hand, ID=6 is assigned to t the succeeding section of 60 frames set after the snap pan motion section, and “after snap pan” is registered as the corresponding type.

Next, in step S1702, the ratio obtainment unit 203 determines whether or not the type of the motion section corresponding to ID=i is “snap pan”. As a result of this determination, when the type of the motion section corresponding to ID=i is “snap pan”, the process proceeds to step S1703, and when the type of the motion section corresponding to ID=i is not “snap pan”, the process proceeds to step S606. In step S1703, the ratio obtainment unit 203 registers 0 in the motion section table 1601 as the ratio corresponding to ID=i.

As described above, according to the present embodiment, a snap pan section in which the content of the video is difficult to confirm is excluded from the highlight section candidates, and sections whose ratio of an object being detected is high before and after a snap pan can be selected as a highlight section in which the photographer shot the object intentionally. Therefore, it is possible to extract, as a highlight section, a section with a high possibility being particularly meaningful to the photographer, in the “frame section in which the photographer is moving while shooting”.

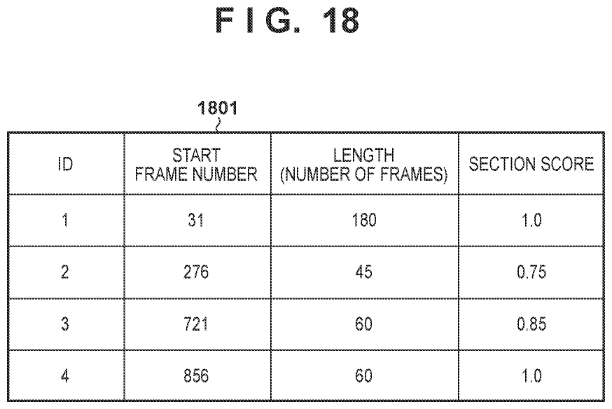

An object detected in a section after a snap pan is empirically more important than an object detected before a snap pan. Therefore, configuration may also be taken such that a section after a snap pan can be preferentially selected by setting the section score of the section (after snap pan) having the ID=4 higher than the section (before snap pan) having the ID=3 as in a highlight section table 1801 illustrated in FIG. 18. More specifically, when the section scores are set in step S1102 and step S1106, a subtraction point may be performed when the type is “before snap pan”, or an addition point may be performed when the type is “after snap pan”.

The numerical values used in each of the embodiments described above are merely examples given to describe the embodiments in an easily understandable manner, and are not intended to be limited to the numerical values given in the above description.

In the above embodiment, a form of obtainment of information included in frame information of an image and information calculated from the image or the frame information on the side of the image processing apparatus is not limited to the form described above. For example, a part of the information described as the information included in the frame information of the image may be obtained on the image processing apparatus side, or a part of information obtained from the image or the frame information may be included in the frame information on the image processing apparatus side.

In addition, some or all of the above described embodiments and modifications may be used in combination as appropriate. In addition, some or all of the above described embodiments and modifications may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-204345, filed Oct. 30, 2018, which is hereby incorporated by reference herein in its entirety.

What is claimed is:

1. An image processing apparatus comprising:
a specifying unit configured to specify in a moving image, as a motion section, a frame section including a plurality of consecutive frames related to a motion of a photographer of the moving image;
an obtaining unit configured to obtain a ratio of frames in which a specific object is detected from among the plurality of frames forming the motion section; and
a determining unit configured to determine, from one or more motion sections specified from the moving image by the specifying unit, based on the ratio obtained by the obtaining unit for each of the one or more motion sections, a motion section to be extracted as a highlight.

2. The image processing apparatus according to claim 1, wherein the highlight is a characteristic scene within the moving image.

3. The image processing apparatus according to claim 1, wherein the determining unit, from among the respective motion sections specified from the moving image by the specifying unit, determines, as the motion section to be extracted as the highlight, a motion section in which the ratio obtained by the obtaining unit is equal to or larger than a threshold value.

4. The image processing apparatus according to claim 1, wherein the specifying unit specifies the motion section based on an angular velocity in a pitch direction at a time of capturing an image of each frame in the moving image.

5. The image processing apparatus according to claim 1, wherein the specifying unit specifies the motion section based on a motion vector between frames in the moving image.

6. The image processing apparatus according to claim 1, wherein the motion section specified by the specifying unit is a section including a plurality of frames that the photographer shot while moving.

7. The image processing apparatus according to claim 1, wherein the specific object is a face of a person.

8. The image processing apparatus according to claim 7, wherein the motion section to be extracted as the highlight includes, from among the motion sections shot by the photographer while following the person, a section in which a frequency of the person looking back is higher than a reference.

9. The image processing apparatus according to claim 1, wherein the obtaining unit obtains a ratio of frames in which an object of a specific class is detected within the motion section.

10. The image processing apparatus according to claim 9, wherein the object of the specific class is a face of a person registered in advance.

11. The image processing apparatus according to claim 1, wherein the obtaining unit obtains a ratio of frames in which the specific object positioned at image coordinates of a defined range is detected within the motion section.

12. The image processing apparatus according to claim 1, wherein the obtaining unit obtains a ratio of frames in which the specific object of a size of a defined range is detected within the motion section.

13. The image processing apparatus according to claim 1, wherein the determining unit
sets a first score to a motion section in which the ratio obtained by the obtaining unit is equal to or larger than a threshold value from among each motion section specified from the moving image by the specifying unit,
sets, a second score for a concentrated section determined to be a section in which frames in which an object is detected are concentrated, in each motion section specified from the moving image by the specifying unit, and
determines, based on the first score and the second score, a motion section in which the ratio obtained by the obtaining unit is equal to or larger than a threshold value and a motion section to be extracted as the highlight from the concentrated section.

14. The image processing apparatus according to claim 13, wherein the first score is greater than the second score.

15. The image processing apparatus according to claim 13, wherein the first score includes a score corresponding to image quality of a motion section in which the ratio obtained by the obtaining unit is equal to or larger than a threshold value, and the second score includes a score corresponding to image quality of the concentrated section.

16. The image processing apparatus according to claim 1, wherein the motion section includes sections before and after a snap pan section in the moving image.

17. The image processing apparatus according to claim 1, further comprising: a unit configured to generate and output a highlight moving image in which groups of frames in each motion section determined by the determining unit are connected.

18. The image processing apparatus according to claim 1, further comprising: a unit configured to generate and output a photo book by using frames in each motion section determined by the determining unit.

19. An image processing method performed by an image processing apparatus, the method comprising:
in a moving image, specifying, as a motion section, a frame section including a plurality of consecutive frames related to a motion of a photographer of the moving image;
obtaining a ratio of frames in which a specific object is detected from among the plurality of frames forming the motion section; and
determining, from one or more motion sections specified from the moving image, based on the ratio obtained for each of the one or more motion sections, a motion section to be extracted as a highlight.

20. A non-transitory computer-readable storage medium storing a computer program for causing a computer to function as:
a specifying unit configured to specify in a moving image, as a motion section, a frame section including a plurality of consecutive frames related to a motion of a photographer of the moving image;
an obtaining unit configured to obtain a ratio of frames in which a specific object is detected from among the plurality of frames forming the motion section; and
a determining unit configured to determine, from one or more motion sections specified from the moving image by the specifying unit, based on the ratio obtained by the obtaining unit for each of the one or more motion sections, a motion section to be extracted as a highlight.
